(19) United States
(12) Patent Application Publication
(10) Pub. No.: US 2013/0026197 A1
(43) Pub. Date: Jan. 31, 2013

(54) APPLICATION HEAD FOR DISPENSING A FREE-FLOWING MEDIUM AND APPLICATION DEVICE FOR DISPENSING A FREE-FLOWING MEDIUM

(71) Applicants: Hanspeter Felix, Strengelbach (CH); Roman Kappeler, Muri (CH); Heinz Mueller, Gelterkinden (CH)

(72) Inventors: Hanspeter Felix, Strengelbach (CH); Roman Kappeler, Muri (CH); Heinz Mueller, Gelterkinden (CH)

(73) Assignee: Robatech AG, Muri (CH)

(21) Appl. No.: 13/575,397

(22) PCT Filed: Jan. 25, 2011
(86) PCT No.: PCT/EP2011/050991

§ 371 Date: Oct. 16, 2012

(30) Foreign Application Priority Data
Jan. 27, 2010 (EP) 10151806.6

(51) Int. Cl. B67D 3/00

(52) U.S. Cl. 222/504

(57) ABSTRACT

The invention relates to an application head (15) for dispensing a free-flowing medium. The application head (15) comprises an injection chamber (10) inside the application head (15) and an injection needle (11) movably mounted inside the injection chamber (10). An opening movement (P) of the injection needle (11) opens an outlet (12). A supply channel (13) and a supply line are also provided in order to introduce the free-flowing medium into the injection chamber (10). A drive (20) generates the opening movement (P) of the injection needle (11). The application head (15) also comprises a lever arm (30), the first end (31) of said arm being movably fixed to a rear end (14) of the injection needle (11) and the second end (32) thereof being connected to the drive. A membrane suspension (33) comprising a membrane (34) is provided, and the lever arm (30) extends through the membrane (34) of the membrane suspension (33). The membrane suspension (33) is used to movably connect the lever arm (30) to the application head (15), and as a seal to prevent the free-flowing medium from leaking out.

The invention relates to an application head for dispensing a free-flowing medium and application device having at least one such application head. In particular, it relates to dispensing adhesives and the use of hot glue. The invention can also be used for the controlled dispensing of cold glue or glue which comprises aggressive (e.g., corrosive) components.

The priority of application EP 10151806.6, which was filed on 27 Jan. 2010 with the European Patent Office, is claimed.

### BACKGROUND OF THE INVENTION, PRIOR ART

In numerous industrial manufacturing processes, adhesives, sealants, and similar free-flowing media are used, which are applied or sprayed in liquid form onto a workpiece or substrate.

The corresponding application heads must be robust and allow precise, high-precision dispensing of the medium. The application heads are simultaneously to be rapidly switchable, in order to be able to portion out adhesive quantities or apply them precisely in points or strips. In addition, the application heads are not to be excessively large, since frequently only limited space is available in the corresponding application devices.

Furthermore, application heads are to be flexibly usable and are to be able to be refitted as needed or preferably are to be able to be switched over or monitored at the controller.

Further problems arise if hot glue is to be processed. Thus, for example, the great heat in the interior of an application head can damage the drive unit. There are also types of glue which contain additives, which can be aggressive. The pH value of a glue can thus be in the acid range, for example. Glue can also contain corrosively or abrasively acting components. In order to protect an application head therefrom, suitable measures must be taken.

The problem presents itself of providing a precisely operating and reliable application head which avoids or entirely remedies a part of the disadvantages of previously known solutions.

The problem is solved by an application head according to claim 1 and by an application device having corresponding control module according to claim 6.

A first application head according to the invention is especially designed for dispensing a free-flowing medium. It comprises a (nozzle) chamber in the interior of the application head and a nozzle needle, a needle valve, or a slide (designated here in summary as a “movable element”), which is mounted so it is movable in the interior of the nozzle chamber. The movable element executes a movement and releases an outlet opening for a short time in each case. The application head can also act in reverse, in that the movable element closes an outlet opening for a short time in each case. A supply channel is provided, which is connected to the (nozzle) chamber and is connectable with respect to flow to a supply line. The free-flowing medium can be introduced into the (nozzle) chamber through the supply line and the supply channel. A drive generates the opening movement or closing movement of the movable element. A lever arm is provided, whose first extremal end is fastened so it is movable on a rear end of the movable element and whose second extremal end is connected/coupled to the drive. Furthermore, the application head comprises a membrane suspension having a membrane. The lever arm extends essentially perpendicularly through a surface spanned by the membrane of the membrane suspension. The membrane is used for the purpose of connecting the lever arm to the application head so it is movable. Furthermore, the membrane suspension is used as a seal to prevent an escape of the free-flowing medium from the (nozzle) chamber. In addition, the membrane is preferably implemented so that it is resistant in relation to the free-flowing medium. In all embodiments, the membrane is preferably temperature-resistant and/or corrosion-resistant and/or abrasion-resistant and/or resistant in relation to chemical additives in the medium.

Depending on the embodiment, the membrane can comprise at least one sealing ring, which is used as a seal and for elastically clamping the membrane in the application head. This embodiment can be used in all embodiments of the invention and offers an improved seal in relation to escaping adhesive, for example.

An embodiment is particularly preferred in which there is a metallic membrane, which can execute back and forth movements particularly rapidly and therefore allows rapid opening or closing of the outlet opening. Such a metallic membrane is particularly suitable for alternating load at high frequency, i.e., for embodiments in which very rapid opening or closing is required. A metallic membrane is particularly advantageous and can be used in all embodiments of the invention.

The invention is very particularly suitable for thermoplastic (hot melt) adhesives. However, it is also suitable for aggressive types of glue and, e.g., for cold glue.

Further advantageous embodiments of the invention are set forth in the dependent claims.

### FIGURES

Further details and advantages of the invention are described in greater detail hereafter on the basis of exemplary embodiments and partially with reference to the drawings. All figures are schematic and are not to scale and corresponding structural elements are provided with identical reference numerals in the various figures, even if they are differently formed in detail. It shows:

FIG. 1 a schematic perspective view of a first embodiment of the invention;

FIG. 2 a schematic sectional view of a further embodiment of the invention;

FIG. 3A a top view of a membrane of a further embodiment of the invention;

FIG. 3B a perspective sectional view of a membrane suspension of a further embodiment of the invention;

FIG. 4 an enlarged schematic sectional view of a further embodiment of the invention;

FIG. 5 a schematic side view of a further embodiment of the invention;

FIG. 6A a sectional illustration of a further embodiment of the invention in which a preferred thermally-decoupled connection between a drive and an application head can be recognized;

FIG. 6B an enlarged sectional illustration of FIG. 6A;

FIG. 7A a schematic illustration of an exemplary movement profile (movement P) of the movable element;

FIG. 7B a schematic illustration of the corresponding drive-side movement profile (movement P1);

FIG. 8 a schematic illustration of a further drive-side movement profile (movement P1) having only two parameters;

FIG. 9 a schematic illustration of a further drive-side movement profile (movement P1) having four parameters;

FIG. 10 a schematic sectional view of a further embodiment of the invention based on the embodiment shown in FIG. 2, details of the control module and a control loop being schematically indicated.

### DETAILED DESCRIPTION OF THE EXEMPLARY EMBODIMENTS

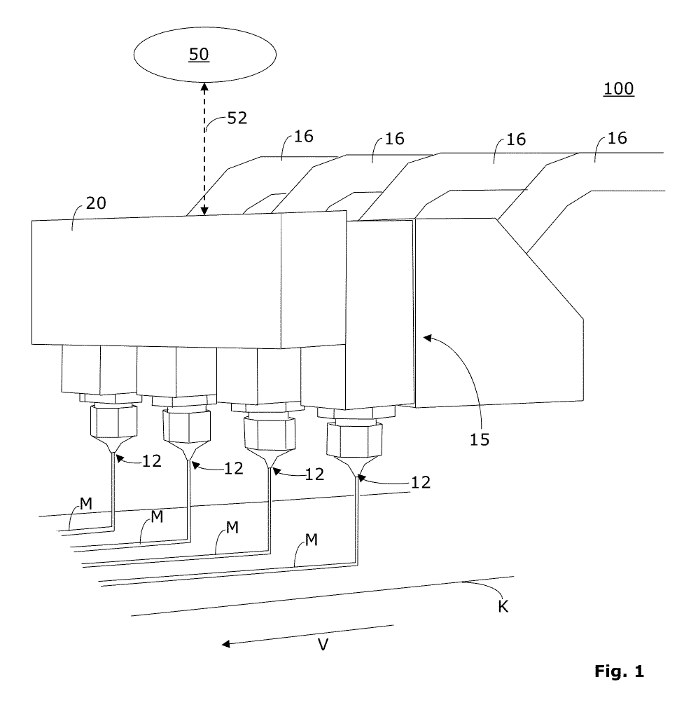

The principle of the invention will be described hereafter on the basis of a first embodiment. FIG. 1 shows an application device 100 having multiple application heads 15 arranged in a row, nozzle outlet openings 12, and having individually switchable adhesive supply lines 16. Instead of the nozzle outlet openings 12 shown, other outlet openings 12 can also be used. The shape, arrangement, and design of the outlet openings 12 can be dependent on whether a nozzle needle, a needle valve, or a slide is used as the movable element 11 in the interior of the application head 15.

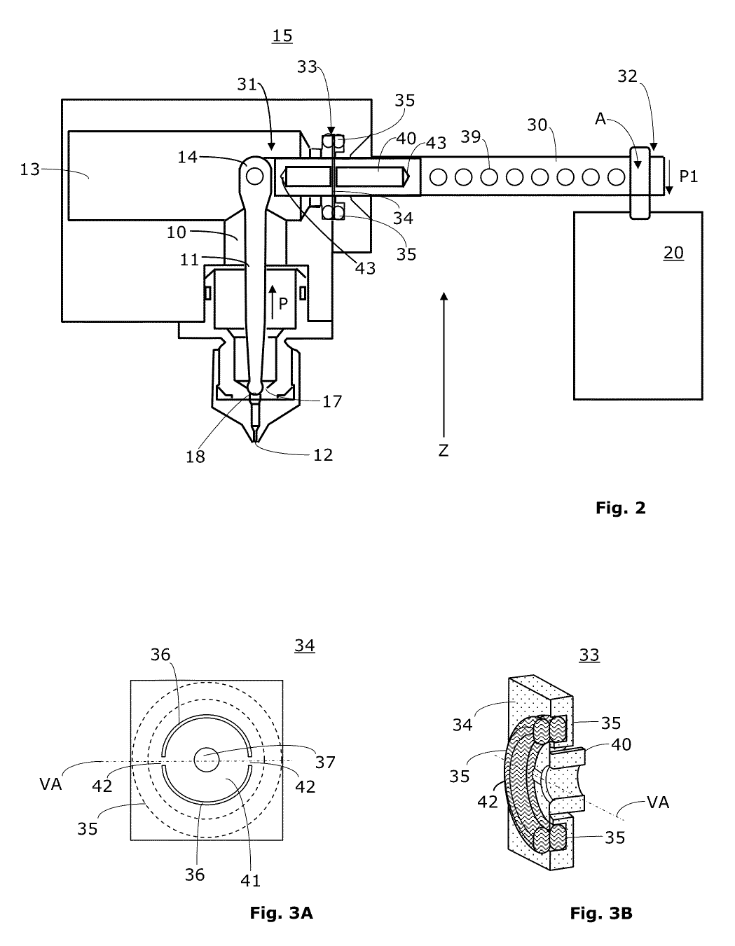

Each of the outlet openings 12 is implemented on or in a respective application head 15. Each application head 15 is especially designed for dispensing a free-flowing medium M, preferably adhesive, and comprises a (nozzle) chamber 10 in the interior of the application head 15. In the example shown, a nozzle needle 11 is mounted so it is movable up and down in the interior of the (nozzle) chamber 10, the nozzle needle releasing the outlet opening 12 through an opening movement P of the nozzle needle 11. An arrow P is shown in FIG. 2, which is directed upward. An opening movement in arrow direction P raises the nozzle needle 11 and the needle releases the outlet opening 12, so that the medium M can escape from the nozzle chamber 10 through the outlet opening 12. In FIG. 1, four application heads 15 simultaneously permanently dispense a medium M in strip-shaped webs (beads). The strip shape arises because of the passing movement of a paper web K or a workpiece or a substrate. The corresponding movement direction is identified by V.

FIG. 1 shows a (multichannel) control module 50, which is connected with respect to control via a control connection 52 (also referred to as a control operational link) to the drive 20. Such a control module 50 can be used in all embodiments.

In the interior, a supply channel 13 is provided (see, e.g., FIG. 2), which is connected to the (nozzle) chamber 10. The supply channel 13 is connectable with respect to flow to a supply line 16 (see, e.g., FIG. 1), in order to be able to introduce the free-flowing medium M into the (nozzle) chamber 10. Four separate supply lines 16 are indicated in FIG. 1. However, a common supply line 16 can also be used for multiple application heads 15.

Furthermore, a drive 20 is provided for generating the opening movement P of the nozzle needle 11. In FIG. 1, the drive 20 is attached or flanged on the application heads 15. The drive 20 preferably comprises a separate drive 20 per application head 15, so that each outlet opening 12 can be opened and closed individually (i.e., independently of the others). A multichannel control module 50, which has one channel per drive 20, is used in this case.

Embodiments in which the drive 20 is arranged spaced apart from the application head 15, as can be seen in FIG. 2, for example, are particularly preferred. However, it is important in the arrangement of the drive 20 in relation to the application head 15 (this statement applies for arrangements according to FIG. 1 and FIG. 2), that the mutual spacing is precisely defined and stable. This aspect is important, since any spacing change can have an influence on the function or mode of operation of the lever arm 30. Details on the lever arm 30 are described hereafter.

Further details will be explained on the basis of another embodiment, which is shown in a section in FIG. 2. FIG. 2 shows a section through an individual application head 15, in which the drive 20 is arranged spaced apart (i.e., spatially separated). According to the invention, the application head 15 comprises one lever arm 30 per drive 20, whose first extremal end 31 is fastened so it is movable on a rear end 14 of the nozzle needle 11 or another movable element and whose second extremal end 32 is connected to the drive 20. A membrane suspension 33 having a membrane 34 is used, the lever arm 30 extending through the membrane 34 of the membrane suspension 33. The membrane suspension 33 is used for the purpose of connecting the lever arm 30 to the application head 15 so it is movable. In addition, the membrane suspension 33 is used as a seal to prevent the free-flowing medium M from escaping from the (nozzle) chamber 10. I.e., the membrane 34 or the membrane suspension 33, respectively, has a double function. In addition, depending on the design of the membrane 34, it has a protective function in relation to temperature, corrosion, abrasion, and chemical additives of the medium M.

The following further details distinguish this embodiment. However, these details are also applicable to all other embodiments. The (nozzle) chamber 10 is implemented so that in its lower region, close to the outlet opening 12, a stop point 17 or a stop surface (also referred to as a needle seat), respectively, is provided for the tip 18 of the nozzle needle 11. In FIG. 2, the nozzle needle 11 is shown in the closure position, i.e., the tip 18 of the nozzle needle 11 is seated sealed on the stop point 17 and no medium M can escape through the outlet opening 12. As soon as the nozzle needle 11 is raised in the direction of the Z axis by the opening movement P, the outlet opening 12 is released and medium M can escape.

The nozzle needle 11 is connected so it is movable (like a toggle joint) to the lever arm 30 in the region of the rear end 14. The nozzle needle 11 more or less “dangles” in the nozzle chamber 10. Because the nozzle chamber 10 and the nozzle needle 11 are implemented as conically rotationally-symmetric in the lower area (close to the stop point 17), the nozzle needle 11 is guided centered during a downward movement in the −Z direction. In addition, the medium M, which flows from the supply channel 13 through the (nozzle) chamber 11 in the direction of outlet opening 12, contributes to stabilization or self-centering, respectively, of the nozzle needle 11. This type of “dangling” mount or suspension can be applied in all embodiments.

The lever arm 30 is implemented here so that it comprises a flat, rectangular, or strip-shaped rod, which is optionally provided with holes 39 here. These holes 39 are used to make the rod lighter, to reduce the mass to be accelerated. In addition, the holes 39 allow a displacement of the attachment point A of the drive 20. Therefore, if the effective lever arm is to be lengthened, the drive 20 (or the attachment point A, respectively) can be shifted further in the direction of the second extremal end 32 and vice versa. In the example shown, the drive 20 is seated almost on the extremal end 32, i.e., the effective lever arm is relatively long. The closer the drive 20 (or the attachment point A, respectively) is displaced in the direction of the membrane suspension 33, the shorter the effective lever arm. A step-down transmission occurs in the case of a long lever arm, i.e., a large movement P1 causes a small movement P in the opposite direction. The step-down factor in FIG. 2 is approximately 5:1 (i.e., the absolute value of the movement P1 is approximately 5 times as large as the absolute value of the movement P). In the case of a small lever arm, a step-up transmission occurs, i.e., a small movement P1 causes a large movement P in the opposite direction.

A step-down transmission having a step-down factor between 2:1 and 10:1 is preferably used in all embodiments.

However, the lever arm 30 can also have any other rod or lever shape. The lever arm 30 is preferably manufactured from torsion-resistant material. In addition, the lever arm 30 is to be as light as possible, in order to have a small moved or accelerated mass. The membrane 34 is used in all embodiments as a kinematic support, which carries/mounts a part of the mass of the lever arm 30. In addition, the membrane 34 defines the precise pivot or tilting point (referred to as the virtual pivot axis) of the lever arm 30 in all embodiments. The lever arm 30 can also be referred to as a “free-floating” lever because of the special membrane mount 34.

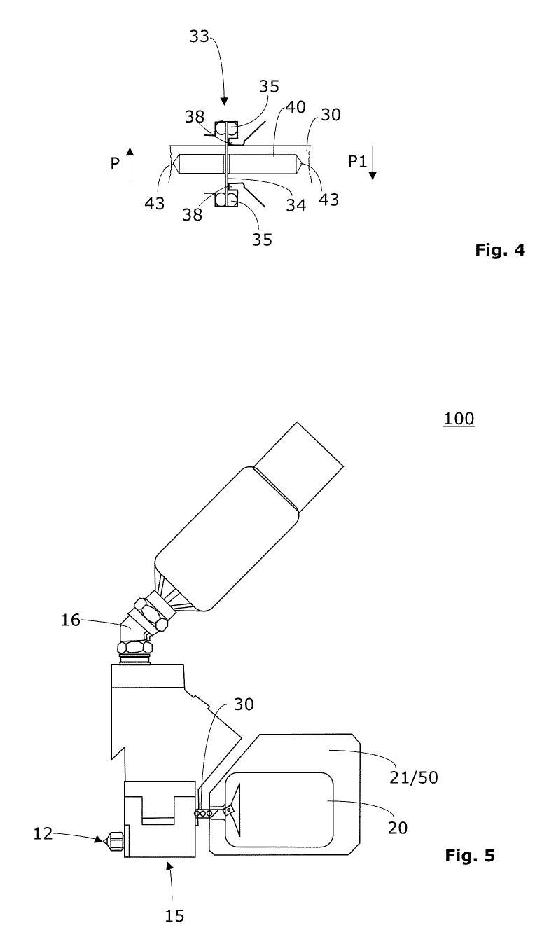

In order to be able to mount or hold the lever arm 30 in the membrane suspension 33, a cylindrical rod 40 is provided on the lever arm 30 in the embodiment shown. This cylindrical rod 40 pinches or clamps the membrane 34 and therefore provides a suspension of the lever arm 30 on the membrane 34. Details of an exemplary preferred arrangement can be inferred from FIG. 4. This type of the suspension can be applied in all embodiments.

Furthermore, FIGS. 2 and 4 show that the membrane 34 can comprise one or two sealing rings 35, which allow the membrane 34 to be elastically clamped in the application head 15. The sealing rings 35 are optional. For the purpose of clamping, the application head 15 can comprise a removable part or a lid (not shown in detail). If this part or this lid is removed, the membrane 34 including the optional sealing rings 35 can be inserted. The mentioned part or the lid is then fastened again and the membrane 34 is clamped.

FIG. 4 shows that on the rear side of the membrane 34, i.e., on the side which faces away from the (nozzle) chamber 10, an optional pressure connecting part 38 is provided, which is used as a mechanical stop for the membrane 34. Through this preferred embodiment, overstretching of the membrane 34 is prevented in the event of an overpressure in the nozzle chamber 10. The membrane 34 is preferably designed and arranged in all embodiments so that it is only strained by bending, which lengthens the service life.

A metallic membrane 34 is preferably used in the various embodiments, which is particularly suitable for alternating load at high frequencies. A membrane 34 in which either the entire membrane surface consists of metal, or in which a planar membrane substrate (e.g., made of plastic) is provided with a metal layer/metal vapor deposit, is designated as a metallic membrane 34.

Furthermore, FIGS. 2 and 4 show that a counter movement P1, which is caused by the drive 20, causes an opposing opening movement P of the nozzle needle 11. The lever arm thus ensures a definition of the step-down or step-up transmission and a movement reversal.

FIG. 3A shows details of a preferred embodiment of the membrane 34. The membrane 34 comprises slots 36 to increase the elasticity. In addition, a central opening 37 is provided, through which the lever arm 30 extends in the installed state. The location of the sealing ring or rings 35 is indicated in FIG. 3A. This design of the membrane 34 is particularly suitable for metallic membranes 34, in order to provide the metallic membrane 34 with the required elasticity.

Through the special arrangement of the slots 36, which nearly define a complete circle, two small webs 42 result at the positions three o'clock and nine o'clock. These two small webs 42 allow bending of the inner part 41 (i.e., the circular region 41 of the membrane 34 which is delimited on the outside in the radial direction by the slots 36) of the membrane 34. The two small webs 42, with the inner part 41 of the membrane 34, quasi-define a virtual pivot axis VA. This virtual pivot axis VA is shown in FIG. 3 by a dot-dash line.

FIG. 3B shows details of a preferred embodiment of a membrane suspension 33. The fastening of the lever arm 30 on the membrane 34 can be seen here. This fastening is performed by the rod 40, as described. In the embodiment shown, the rod 40 is internally hollow to reduce the weight. In order that no medium M can escape through the interior of the rod 40, the rod 40 can be provided with caps 43 or sealing elements on both ends, for example. The location of the virtual pivot axis VA is also indicated in FIG. 3B. The details shown in FIG. 3B may be applied to all embodiments.

FIG. 5 shows details of a further embodiment of the invention. The arrangement of the elements is selected differently here, but the function is the same. A linear movement of the drive 20 is converted into an opening movement of the nozzle needle 11 in the interior of the application head 15. The drive 20 is also implemented separately (i.e., spaced apart) from application head 15 here, as also in FIG. 2.

In the various described embodiments, an

electromagnetic or

pneumatic or

piezoelectric drive

is suitable as the drive 20, which generates a corresponding linear movement P1 (up and down movement) at the desired frequency, which is relayed by the effective active lever arm 30 through a step-down or step-up transmission to the nozzle needle 11 and induces the linear movement P therein. In the case of a piezoelectric drive 20, however, one preferably operates with a step-up transmission, in order to convert the very small movements of the piezoelectric drive 20 into sufficiently large opening and closing movements P.

An electromagnetic drive 20 which is constructed according to the principle of a voice coil motor or a Lorentz coil has particularly proven itself. In this case, a 1:1 lever transmission ratio or a step-down transmission is particularly suitable in this case as the effective transmission ratio. A voice coil motor or a Lorentz coil can be used in all embodiments.

A voice coil drive 20 has the advantage that it is deenergized in the idle state, i.e., the power consumption is less than in previous application heads.

The stroke in the region of the nozzle tip 18 or the outlet opening 12 in the direction of the Z axis is preferably between 0.1 mm and 1 mm. In the case of a 1:1 lever transmission ratio, the drive 20 must thus make a corresponding movement P1 in the opposite direction having a stroke of 0.1 mm to 1 mm.

With a suitable control of the drive 20, e.g., via a driver module 21 and/or a control module 50, which can be arranged in the proximity of the drive 20, as indicated as an example in FIG. 5, the movement behavior of the nozzle needle 11 or another movable element can be set or even regulated. If desired, a suitable movement profile can be stored, so that the nozzle needle 11 is decelerated shortly before it is incident on the stop point 17. This measure lengthens the service life of the nozzle needle 11 and the application head 15. A corresponding driver module 21 and/or control module 50 can be used in all embodiments.

The greater the lever step-down transmission ratio is selected to be, the more precisely may the nozzle needle 11 be moved, because a large movement P1 of the drive 20 is stepped down into a small movement P of the nozzle needle 11. A disadvantage of such a large step-down transmission ratio, however, is the lengthened route which must be covered on the drive side. The achievable frequency or the maximum cycle, respectively, of the opening and closing movement of the nozzle needle 11 is thus possibly reduced.

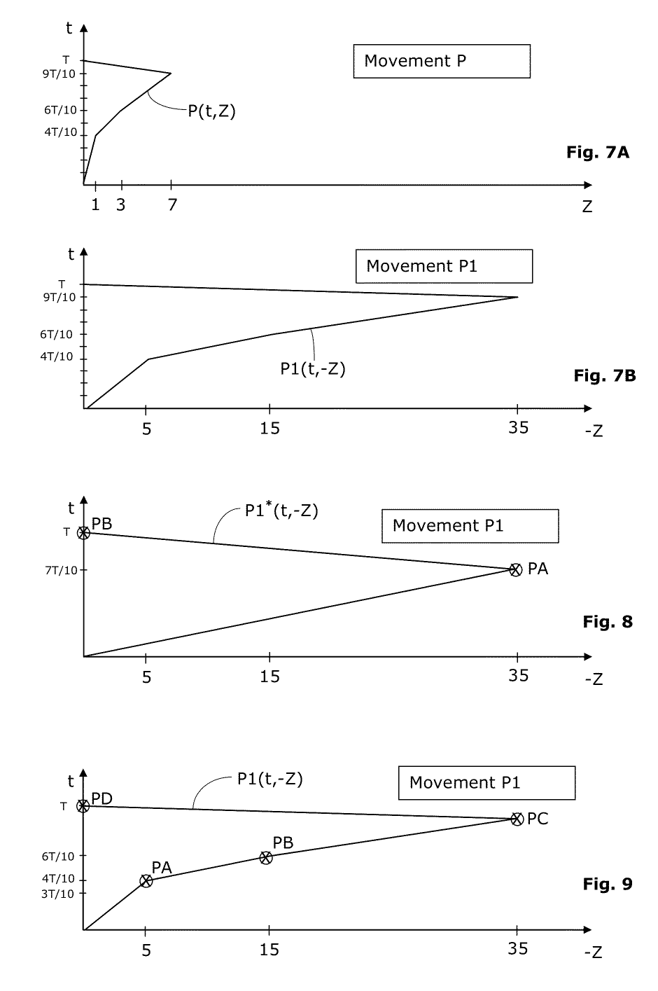

FIG. 7A shows a schematic illustration of an exemplary movement profile (movement P) of the movable element 11. The movement profile P(t, Z) is composed of multiple line segments. In practice, a movement profile P(t, Z) having a curved course is preferably used. The movement profile P(t, Z) is a function of the time t and the distance Z here. An opening and closing cycle has a duration T here. The duration T is decomposed into 10 cycle units of equal length here, for example. The exemplary movement profile P(t, Z) can be described as follows. At the point in time t=0, the movable element 11 begins to move in the positive Z direction to release the outlet opening 12. The movement is linear and at 9T/10 reaches a maximum point at Z=7 (the unit of the Z axis can be specified in millimeters or another unit, for example). At the point (t=9T/10, Z=7), the opening movement is completed and a direction reversal occurs, which does not run as abruptly in practice as shown in the schematic illustrations. The closing movement preferably extends very steeply, since it is important for the tear-off behavior that the outlet opening 18 is closed rapidly with a large force. The curve extension between the point (t=9T/10, Z=7) and the point (t=T, Z=0) is linear here. However, this extension is preferably nonlinear, which can be achieved, for example, by a suitable membrane 34 having nonlinear properties. Upon reaching the point (t=T, Z=0), the closing movement is ended. I.e., at t=T, the movable element 11 has again reached the closure position at Z=0.

FIG. 7B shows a schematic illustration of the corresponding drive-side movement profile P1(t, Z). The curve P1(t, Z) corresponds to the curve P(t, Z) here, stretching in the Z direction having been performed by the step-down transmission factor 5. In addition, P1(t, Z) extends in the −Z direction. Of course, the curve P1(t, Z) only corresponds to the curve P(t, Z) if the system of the individual components is infinitely stiff and if there are no transmission, friction, or other losses and inaccuracies.

FIG. 7B indicates that the step-down transmission ratio causes a stretching (in the Z direction), which improves the ability to parameterize and/or activate.

Complete parameterization of the curve P(t, Z) can be given by the following value pair matrix (if the curve P(t, Z) is a traverse made of linear segments):

(t=0, Z=0)
(t=4T/10, Z=1)
(t=6T/10, Z=3)
(t=9T/10, Z=7)
(t=T, Z=0).

A complete parameterization of the curve P1(t, −Z) can be given by the following value pair matrix (if the curve P1(t, −Z) is a traverse made of linear segments):

(t=0, −Z=0)
(t=4T/10, −Z=5)
(t=6T/10, −Z=15)
(t=9T/10, −Z=35)
(t=T, −Z=0).

FIG. 8 shows a schematic illustration of a corresponding drive-side movement profile P1*(t, −Z), which is only defined here by two parameters PA and PB. The drive-side movement profile P1*(t, −Z) only has a linear opening movement from (t=0, −Z=0) to (t=7T/10, −Z=35) and a steeper (i.e., more rapid) linear closing movement from (t=7T/10, −Z=35) to (t=T, −Z=0) here. It is obvious that the specification of a movement profile is only expedient if more than two parameters are predefined for the parameterization.

The parameters PA and PB of all embodiments are preferably distance-correlated parameters.

FIG. 9 shows a schematic illustration of the corresponding drive-side movement profile P1(t, −Z), which is defined by four parameters PA, PB, PC, and PD. The movement profile P1(t, −Z) in FIG. 9 corresponds to the movement profile P1(t, −Z) in FIG. 7B.

During the parameterization, in all embodiments, in addition to specifying/predefining the parameters (or the value pairs, respectively), the maximum points, and slope changes, further parameters can also be predefined. These further parameters can describe, for example, the extension of the curve between two value pairs. The further parameters can also establish, for example, the cycle duration T and/or the timing (e.g., T/10).

In a preferred embodiment, on the drive side, an intelligent controller (e.g., in the form of the driver module 21 and/or control module 50) of the drive 20 is designed so that the current which is fed into the drive 20 is observed. When the current increases, this is an indication that the nozzle needle 11 or the movable element is at the stop point 17. Through an intelligent control module 50, a gradual adaptation of the movement profile stored in the driver module 21, which can be defined in all embodiments by the cited parameterization, can be performed, which compensates for wear of the needle tip 18 in that the movement P1 on the drive side is successively increased when the current signal indicates that the current increase only occurs later in relation to earlier. This is because the later occurrence of a current increase means that the needle tip 18 is at the stop point 17 later than heretofore. This is an indication of wear. The use of such an intelligent controller (e.g., in the form of the driver module 21 and/or control module 50) lengthens the service life of the application head 15, since the nozzle needle 11 or the movable element must only be replaced later.

In a preferred embodiment, on the drive side, an intelligent controller (e.g., in the form of the driver module 21 and/or control module 50) of the drive 20 is designed so that the movement of the nozzle needle 11 or the movable element is regulated according to a predefined movement profile (e.g., P1(t, −Z)). The switching times and the stroke of the nozzle needle 11 can be monitored and the application picture of the application head 15 can be automatically corrected by the control module 50.

The driver module 21 and/or the control module 50 is preferably located directly on each drive 20, so that the drive 20 can be activated directly using a 24 VDC signal (also directly by a PLC) (PLC stands for programmable logic controller). This has the advantage that each application head 15 can be activated individually. A corresponding driver module 21 and/or control module 50 can be used in all embodiments.

In a preferred embodiment, on the drive side, an intelligent controller of the drive 20 is designed so that error, warning, service, or maintenance indicators are output. The control module 50 is appropriately equipped and/or programmed for this purpose. This approach can be used in all embodiments.

It is an advantage of the invention that a spatial thermal separation (see, e.g., FIG. 5) is possible between drive 20 and the part of the application head 15 around which the medium M flows. Particularly in the case of warm or hot medium M, the problems are thus reduced which can otherwise be caused on the drive side due to the high temperature.

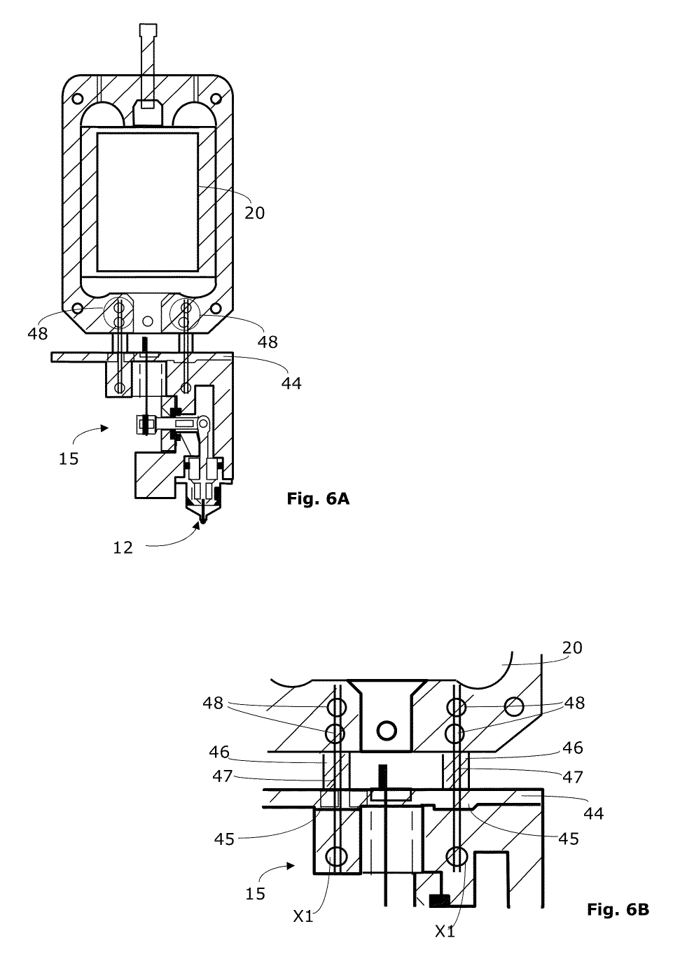

The thermal separation between drive 20 and application head 15 is preferably achieved without a screw connection, as can be seen in FIG. 6A and the detail enlargement 6B. An insulation plate 44 is laid on the application head 15. The insulation plate 44 is implemented on the application head side having two positioning bolts 45 and on the drive side having four spacer/positioning bolts 46. The fixation of application head 15 and drive 20 is performed via two cables 47 (preferably steel cables). A non-heat-conductive cable 47 is preferably used. The cables 47 are fixed on application head 15 at the point X1 and are tensioned in the drive 20 by a tensioning device 48. Through this arrangement, the application head 15 and the drive 20 are ideally fastened without a metallic connection (in the present arrangement solely by two thin cables 47).

In all preferred embodiments, the lever arm 30 causes a reversal of the movement direction (P1 points in the opposite direction as P; see FIG. 2) and, depending on the setting of the lever arm lengths, a movement amplification (P>P1; referred to as step-up transmission) or a movement reduction (P1>P; referred to as step-down transmission). In addition, the angled arrangement of the lever arm 30 in relation to the movable element 11 allows an arrangement of the membrane 34 in a region which is not directly subjected to the flowing medium M.

The invention allows a precise custom adhesive application. It can be used in electromagnetic, electropneumatic, piezoelectric, or electromechanical application heads 15, whether hot or cold glue processes, whether based on distance or time, and whether constant or variable substrate speed.

The control module 50 (also referred to as the application controller) can be integrated directly in the device (e.g., in a melting device), or it can be provided as an independent unit. It is also possible according to the invention to control and monitor multiple application heads 15 from a common (multichannel) control module 50, as indicated in FIG. 1.

Embodiments are particularly preferred in which the control module 50 is designed so that it can be controlled/monitored by a PLC.

In all embodiments, the control module 50 has a connection to guidance systems via a typical interface (e.g., a CAN interface).

The control module 50 preferably has a capability for parameterization, as described, in all embodiments. The parameterization can either be performed directly at the controller 50, or the parameterization can be performed indirectly via an interface of the control module 50.

A software module for parameterization is preferably used in all embodiments.

The term “parameterization” is used here to describe that the activation of the application head or heads 15 is performed based on parameters (preferably in the form of value pairs). The parameters are converted by the controller 50 into commands, regulating variables, or values which induce a result on or in the application head 15 (e.g., through implementation in the driver module 21). The parameters can be used, for example, to drive the drive 20 so that at the output side, i.e., at the movable element 11, a monitored opening movement P(t, Z) is induced. This can be achieved, for example, in all embodiments via a programmable output voltage profile or output current profile at the drive 20 or at the driver module 21. The parameters, which are predefined by the parameterization define, e.g., the output voltage profile or output current profile. The output voltage profile or output current profile is then correlated with the movement profile P1(t, −Z) and, via the lever arm 30, with the movement profile P(t, Z).

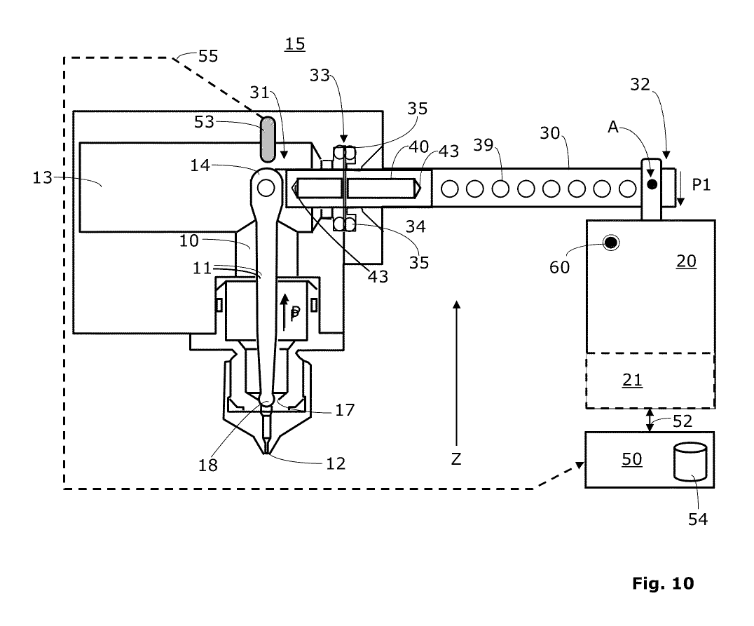

FIG. 10 shows a schematic sectional view of a further embodiment of the invention based on the embodiment shown in FIG. 2, details of the control module 50 and a control loop being schematically indicated. Reference is made to the description of FIG. 2. Only the essential aspects of the activation and the control loop are described hereafter. All embodiments of the invention preferably have a control loop having a (distance or position) sensor 53 (an inductive sensor here, for example) and a control module 50. The sensor 53 is designed for the purpose of detecting the instantaneous position (actual position) of the movable element 11. The (distance or position) sensor 53 is schematically shown in FIG. 10. It can also be arranged at another location. The (distance or position) sensor 53 is connected via a connection 55 to an input of the control module 50, to transfer the actual position to the control module 50. The control module 50 ascertains on the basis of control data, through the comparison with the actual position, whether there is a need for readjustment or correction. If, for example, in the graph in FIG. 7A the closed position (T=t, Z=0) is reached and the (distance or position) sensor 53 indicates an actual position deviating therefrom, in a control loop, the movable element 11 can be moved, e.g., a small amount further in the −Z direction to reach the final closed position (referred to as endpoint monitoring).

If the control module 50 is implemented as self-learning, the corrected parameters, which correspond to the closed position, can be stored in a parameter memory 54. The new parameters are then used during the next opening and closing.

FIG. 10 further indicates that an optional driver module 21 can be provided between the control module 50 and the drive 20 in order to produce the control connection between control module 50 and drive 20. The driver module 21 can receive parameters from the control module 50 and convert them into current or voltage variables (as control variables), which are applied to the drive 20. The control module 50 can also be directly connected with respect to control to the drive 20 (e.g., by a control connection 52, as shown in FIG. 1).

In all embodiments, the parameters PA, PB, etc. are preferably taken from a parameter memory 54 and transferred by the control module 50 to an optional driver module 21. The driver module 21 converts these parameters PA, PB, etc. into control variables. However, it is also possible that the control module 50 processes parameters PA, PB, etc. in order to then transfer processed parameters PA*, PB*, etc. to the driver module 21. The processing of the parameters PA, PB, etc. is dependent on the specific configuration and can take into consideration the step-up or step-down transmission factor, for example.

The control module 50 can be designed, for example, having a module for self-recognition of a clogged nozzle. This self-recognition can recognize an impending nozzle clog on the basis of direct and/or indirect measured information (e.g., from a sensor 53). It can also comprise a module which allows recognition of an impending problem (early recognition). In this case, a preventative warning is preferably performed by the control module 50, for example, via an optional LED maintenance recognition 60 (see FIG. 10). Self-recognition and early recognition may be implemented particularly advantageously in embodiments which have a control loop, as described above.

All embodiments are preferably designed to be self-initializing. For this purpose, the control module 50 makes an initialization run, in order to be able to compare the parameters PA, PB, etc. to the actual values. Initial correction values can be derived therefrom, which are then applied during the productive use.

Through the special mounting of the lever arm 30 using a membrane 34 and through the described control module 50 having parameterizing ability, a precise lead time can be guaranteed in all embodiments. This is important for many applications. If the guaranteed lead time in a first application head 15 is 10 ms, for example, and this application head must be replaced with another application head 15 because of maintenance work, it must be ensured that this second application head 15 also maintains the guaranteed lead time of 10 ms. Additionally or alternatively, the invention guarantees a fixed reaction time (response time) of, e.g., 1 ms, which is important for the activation, e.g., via a PLC.

All application heads 15 behave identically with respect to the fixed reaction time (response time) and/or the lead time.

The invention offers the single electrically driven application head 15 which is activatable using PLC without booster and using a proprietary controller.

The application head 15 is preferably designed in all embodiments so that it is also closed in the non-activated mode or when the device is shut down.

The application head 50 is preferably equipped in all embodiments with a sensor, which monitors the sealing function or leak tightness of the membrane 34. This sensor is designed and arranged so that the medium M escaping in case of fault is detected. The case of fault is transmitted to the controller 50. The controller 50 stops the glue delivery (e.g., by shutting down a pump) using a corresponding control signal. This feature has the advantage that in the event of a fracture of the membrane 34, the escaping medium M can be prevented from being conveyed into the machine.

Inductive, capacitive, or optical sensors, which are preferably arranged in the rear area (i.e., in the medium-free space) of the application head 15, i.e., on the side opposite to the chamber 10, are particularly suitable for monitoring the sealing function or leak tightness of the membrane 34.

The application head 15 is preferably equipped in all embodiments with a monitor of the glue pressure. The controller 50 analyzes (pressure) signals in this case, from which the glue pressure curve may be derived. The analysis of the glue pressure curve allows the controller 50 to perform a diagnosis in the matter of glue conveyance. In this way, for example, an impending nozzle clog and/or the occurrence of a leak on the membrane 34 can be recognized and reacted to. This form of the monitoring of the glue pressure by means of the controller 50 allows simple and reliable monitoring of the glue application.

The application head 15 is preferably equipped in all embodiments with a so-called stroke regulation. This stroke regulation can be used for flow regulation, i.e., for dosing the medium M to be dispensed. For the purposes of the stroke regulation, a distance or position encoder is preferably arranged in the application head 15 in the region of the movable element 11 and/or in the region of the lever arm 30. The current position (actual position) of the movable element 11 and/or the lever arm 30 is thus communicated to the controller 50 and can be used therein for regulating purposes.

Instead of the application head 15, the application device 100 as a whole can also comprise a stroke regulator and/or a sensor monitor and/or a monitor of the glue pressure curve, as described above.

### LIST OF REFERENCE NUMERALS

10 (nozzle) chamber
11 movable element (e.g., nozzle needle)
12 outlet opening
13 supply channel
14 rear end of the nozzle needle 11
15 application head
16 supply line
17 stop point
18 tip
20 drive
21 driver module
30 lever arm
31 first extremal end
32 second extremal end
33 membrane suspension
34 membrane
35 sealing ring
36 slot
37 central opening
38 pressure connecting part
39 holes
40 cylindrical rod
41 inner part of the membrane 34
42 webs
43 cap
44 insulation plate
45 positioning bolt
46 spacer/positioning bolt
47 cable
48 tensioning device
50 control module (application controller)
52 control connection
53 sensor (e.g., induction encoder)/distance meter
54 parameter memory
55 connection
60 LED maintenance notification
100 application device
A attachment point
K paper web
M free-flowing medium
V movement direction
VA virtual axis
P/P(t, Z) opening movement/movement profile
P1/P1(t, Z) counter movement/movement profile
P1*(t, Z) movement profile
PA, B, PC, PD parameters (value pairs)
PA*, PB* processed parameters
t time
T cycle duration
Z axis
X1 points

1. An application head (15) for dispensing a free-flowing medium (M), having
a chamber (10) in the interior of the application head (15),
a movable element (11), which is mounted so it is movable in the interior of the chamber (10), it releasing or closing an outlet opening (12) through a movement (P) of the nozzle needle (11),
a supply channel (13), which is connected to the chamber (10) and is connectable with respect to flow to a supply line (16) to be able to introduce the free-flowing medium (M) into the chamber (10),
a drive (20) for generating the opening movement (P) of the movable element (11), and
having a control module (50),
characterized in that the application head (15) comprises:
a lever arm (30), which is connected to the movable element (11) and the drive (20), to convert a drive-side movement (P1) into an opening or closing movement of the movable element (11),
a membrane suspension (33) having a membrane (34), the membrane suspension (33) being used for the purpose of connecting the lever arm (30) to the application head (15) so it is movable, and
the membrane suspension (33) being used as a seal to prevent the free-flowing medium (M) from escaping from the chamber (10),
and the control module (50) being designed and connected with respect to control to the drive (20) so that at least one parameter (PA) or value pair for the opening and closing movement (P) of the movable element (11) is pre-definable by the control module (50).

2. The application head (15) according to claim 1, characterized in that the membrane suspension (33) comprises, in addition to the membrane (34), at least one sealing ring (35), which is used as a seal and for the elastic clamping of the membrane (34) in the application head (15).

3. The application head (15) according to claim 1, characterized in that the membrane (34) is a metallic membrane (34).

4. The application head (15) according to claim 1, characterized in that the membrane (34)
has slots (36) to increase the elasticity, and
has a central opening (37), through which the lever arm (30) extends in the installed state.

5. The application head (15) according to claim 1, characterized in that the arrangement of the lever arm (30), the movable element (11), and the membrane suspension (33) having the membrane (34) is selected so that the opening or closing movement (P) of the movable element (11) is opposite to the drive-side movement (P1).

6. The application head (15) according to claim 1, characterized in that the at least one parameter (PA) or the at least one value pair, together with a further parameter (PB) or value pair, establishes a movement profile P(t, Z) of the movable element (11).

7. The application head (15) according to claim 6, characterized in that the movement profile P(t, Z) establishes an acceleration and/or braking of the movable element (11).

8. The application head (15) according to claim 1, characterized in that the control module (50) is connected with respect to control to the drive (20) to form a control system, in order to be able to control the opening or closing movement (P) of the movable element (11).

9. The application head (15) according to claim 1, characterized in that a distance meter (53) is provided on the application head (15) for position ascertainment of the position of the movable element (11), to transfer actual variables to the control module (50).

10. The application head (15) according to claim 9, characterized in that the control module (50) is designed for the purpose of comparing the actual variables to the at least one parameter (PA) or value pair and ascertaining a correction or control variable.

11. The application head (15) according to claim 1, characterized in that a step-down transmission of the drive-side movement (P1) into the opening movement (P) of the movable element (11) is caused by the lever arm (30), and the opening or closing movement (P) of the movable element (11) can be parameterized by more than only one parameter (PA, PB) or more than one value pair through this step-down transmission, the parameters (PA, PB) or value pairs being distance-correlated parameters or value pairs.

12. The application head (15) according to claim 11, characterized in that stretching is performed by the step-down transmission, which improves the parameterizing ability and/or the activation ability.

13. The application head (15) according to claim 1, characterized in that the drive (20) is an electromagnetic actuator, and the control module (50) is designed for the purpose of performing an indirect ascertainment of a temperature at the drive (20) on the basis of an ascertainment of a current which is fed into this drive (20).

14. The application head (15) according to claim 1, characterized in that the control module (50) comprises a memory (55) or is connectable to a memory (55), which is designed for the purpose of storing life cycle data and/or parameters (PA).

15. The application head (15) according to claim 14, characterized in that the memory (55) stores life cycle data which permit a statement about
the number of opening or closing movements and/or
wear indicators and/or
clogging indicators.

16. The application head (15) according to claim 1, characterized in that the control module (50) is designed for the purpose of recognizing an impending nozzle clog on the basis of direct and/or indirect measured information.

17. The application head (15) according to claim 1, characterized in that it comprises
a stroke regulator and/or
a sensor monitor and/or
a monitor of the glue pressure curve.

18. An application device (100) for dispensing a free-flowing medium (M), having
a supply line (16) for free-flowing medium (M),
an application head (15) having internal chamber (10),
a movable element (11), which is mounted so it is movable in the interior of the chamber (10), it releasing or closing an outlet opening (12) through a movement (P) of the movable element (11),
a supply channel (13), which is connected with respect to flow to the chamber (10) and the supply line (16), to be able to introduce the free-flowing medium (M) into the chamber (10),
a drive (20) for generating the movement (P) of the movable element (11), and
a control module (50),
characterized in that the application device (100) comprises:
a lever arm (30), which is connected so it is movable to the movable element (11) and the drive (20), in order to convert a drive-side movement (P1) into the movement (P) of the movable element (11),
a membrane suspension (33) in or on the application head (15) having a membrane (34),
which is used for the purpose of connecting the lever arm (30) to the application head (15) so it is movable, and
which is used as a seal to prevent the free-flowing medium (M) from escaping from the chamber (10),
and the control module (50) being designed and being connected with respect to control to the drive (20) so that at least one parameter (PA) or value pair for the opening or closing movement (P) of the movable element (11) is pre-definable by the control module (50).

19. The application device (100) according to claim 18, characterized in that the membrane suspension (33) comprises, in addition to the membrane (34), at least one sealing ring (35), which is used as a seal and for elastically clamping the membrane (34) in the application head (15).

20. The application device (100) according to claim 18, characterized in that the membrane (34) is a metallic membrane (34).

21. The application device (100) according to claim 18, characterized in that the membrane (34)
has slots (36) to increase the elasticity, and
has a central opening (37), through which the lever arm (30) extends in the installed state.

22. The application device (100) according to claim 18, characterized in that an
electromagnetic or
pneumatic or
piezoelectric drive
is used as the drive (20).

23. The application device (100) according to claim 18, characterized in that the application head (15) and the drive (20) are thermally decoupled.

24. The application device (100) according to claim 18, characterized in that the arrangement of the lever arm (30), the movable element (11), and the membrane suspension (33) having the membrane (34) is selected so that the opening or closing movement (P) of the movable element (11) is opposite to the drive-side movement (P1).

25. The application device (100) according to claim 18, characterized in that the at least one parameter (PA) or the at least one value pair, together with a further parameter (PB) or value pair, establishes a movement profile P(t, Z) of the movable element.

26. The application device (100) according to claim 25, characterized in that the movement profile P(t, Z) establishes an acceleration and/or braking of the movable element (11).

27. The application device (100) according to claim 18, characterized in that the control module (50) is connected with respect to control to the drive (20) to form a regulating system, in order to be able to regulate the opening or closing movement (P) of the movable element (11).

28. The application device (100) according to claim 18, characterized in that a distance meter (53) is provided on the application head (15) for position ascertainment of the position of the movable element (11), to transfer actual variables to the control module (50).

29. The application device (100) according to claim 28, characterized in that the control module (50) is designed for the purpose of comparing the actual variables to the at least one parameter (PA) or value pair and ascertaining a correction or regulating variable.

30. The application device (100) according to claim 18, characterized in that a step-down transmission of the drive-side movement (P1) into the opening movement (P) of the movable element (11) is caused by the lever arm (30), and the opening or closing movement (P) of the movable element (11) can be parameterized by more than only one parameter (PA, PB) or more than one value pair through this step-down transmission, the parameters (PA, PB) or value pairs being distance-correlated parameters or value pairs.

31. The application device (100) according to claim 30, characterized in that stretching is performed by the step-down transmission, which improves the parameterizing ability and/or the activation ability.

32. The application device (100) according to claim 18, characterized in that the drive (20) is an electromagnetic actuator, and the control module (50) is designed for the purpose of performing an indirect ascertainment of a temperature at the drive (20) on the basis of an ascertainment of a current which is fed into this drive (20).

33. The application device (100) according to claim 18, characterized in that the control module (50) comprises a memory (55) or is connectable to a memory (55), which is designed for the purpose of storing life cycle data and/or parameters (PA).

34. The application device (100) according to claim 33, characterized in that the memory (55) stores life cycle data, which permit a statement about
the number of opening or closing movements and/or
wear indicators and/or
clogging indicators.

35. The application device (100) according to claim 18, characterized in that the control module (50) is designed for the purpose of recognizing an impending nozzle clog on the basis of direct and/or indirect measured information.

36. The application device (100) according to claim 18, characterized in that it comprises
a stroke regulator and/or
a sensor monitor and/or
a monitor of the glue pressure curve.
